(19) United States
(12) Patent Application Publication
(10) Pub. No.: US 2012/0151820 A1
(43) Pub. Date: Jun. 21, 2012

(54) Boat Buddy Portable Gear Box and Cup Holder

(76) Inventor: Ronald Carroll, Maitland, FL (US)

(21) Appl. No.: 12/972,454

(22) Filed: Dec. 18, 2010

(51) Int. Cl. A01K 97/06

(52) U.S. Cl. 43/54.1

(57) ABSTRACT

The Boat Buddy Portable Gear Keeper and Cup Holder is an aluminum designed boat and/or fishing gear box with hinged lid and attached cup holder. The item is designed to be portable in nature so that it may be positioned anywhere on a boat at the convenience of the boat owner. The design accommodates any type of boat with a rail or gunwale. The front of the box has an attached cork board so that fishing lures may be easily attached and kept handy for quick access. The box is primarily designed for the fisherman who moves to different areas of the boat and has the need to access the contents without having to go to a central location each time an item is needed. This keeps the fisherman from having to move around the boat and minimizes the chances of him or her from losing balance due to restricted movement.

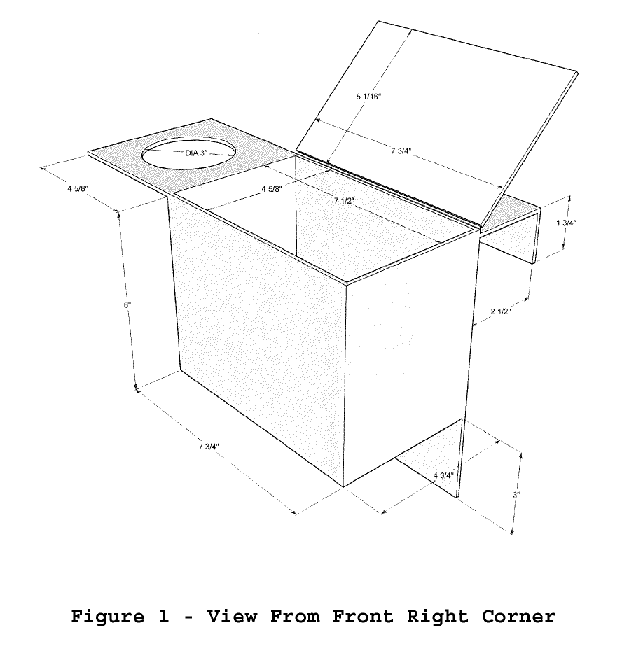

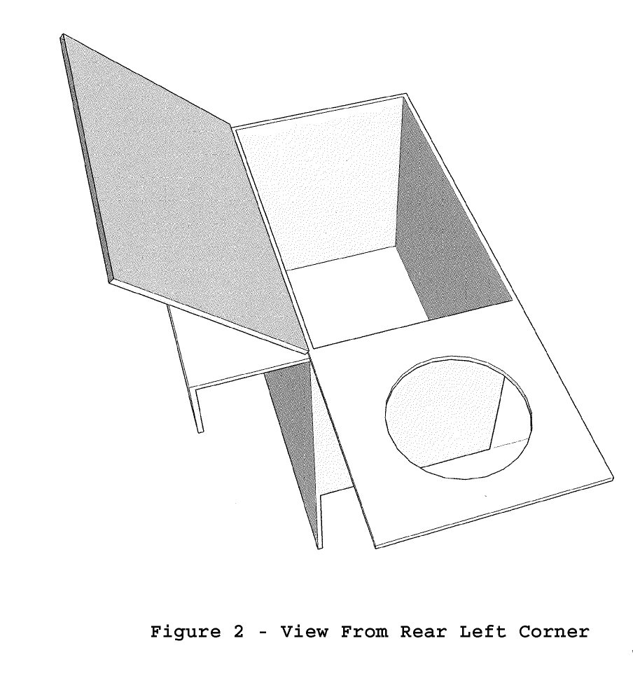

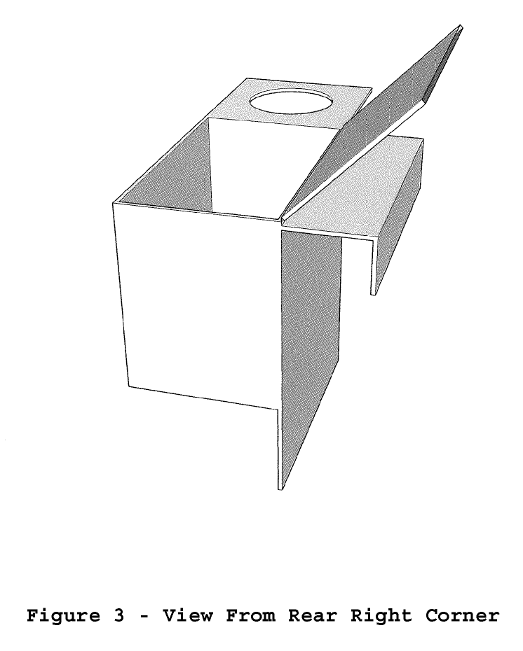

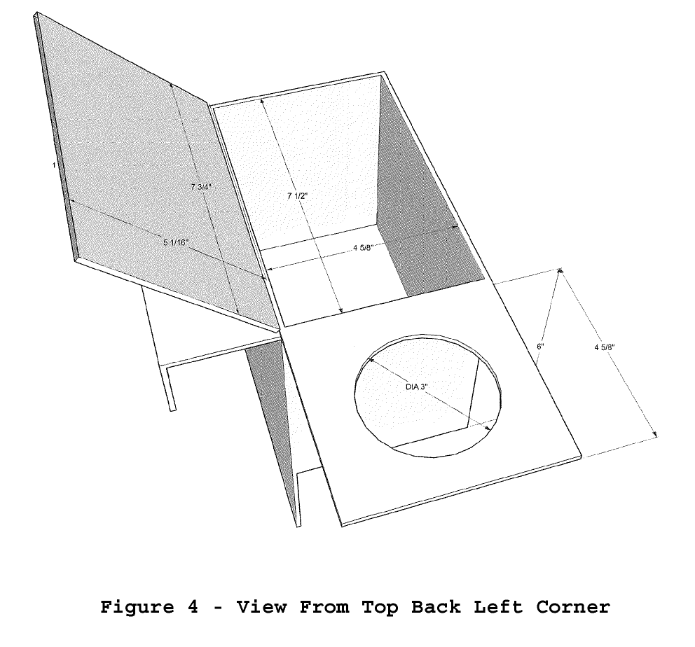

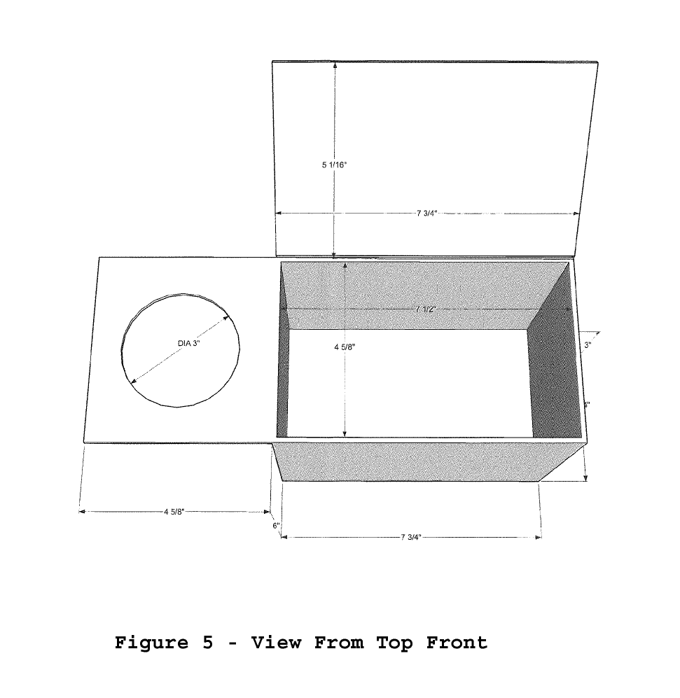

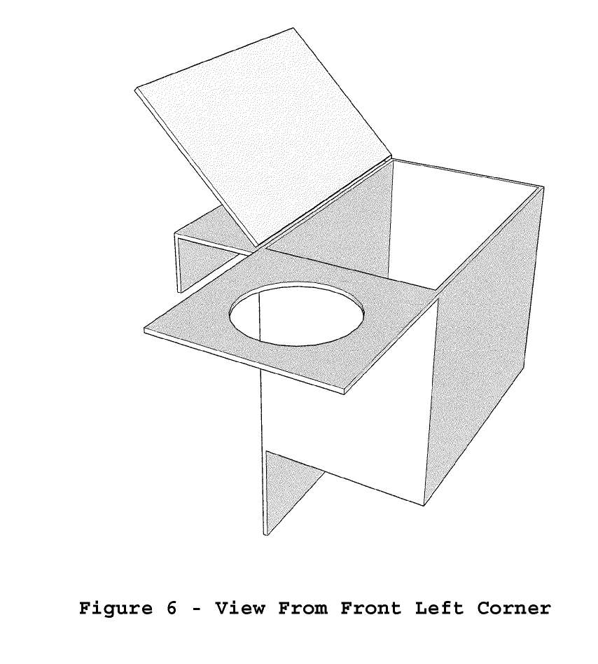

The Boat Buddy Portable Gear Keeper and Cup Holder is an aluminum designed boat and/or fishing gear box with hinged lid and attached cup holder. The boater/fisherman can hang the box on any rail/gunwale of the boat. Boating/fishing gear may be stored in the box portion and protected from the elements by a hinged lid. The cork board front can hold lures keeping them free from fouling. The total size of the item is 12½ inches long by 6 inches high by 4¾ inches deep. The following dimensions of the individual sections of the total component are provided below.

Cup Holder: 4½ inches wide by 4¾ inches deep with a 3 inch diameter opening that accommodates Styrofoam cups or automobile cup holder accessories (i.e. circular ash tray).

Container Box: 7½ inches long by 4½ inches wide by 6 inches deep covered by a hinged lid measuring 8 inches long by 5 inches wide with a small ½ inch flange on the two sides that do not have additional requirements (cup holder and attaching bracket).

Bottom Stability Flange: 8 inches long by 3 inches wide is part of the box and provides stability against boat gunwale so that box stays level against any type of curving gunwale.

Attachment Flange: 8 inches long by 2¼ inches wide with a 90 degree angle measuring 8 inches long by 1½ inches wide for fitting over boat rail or gunwale.

1. This item is designed to help the boater/fisherman keep essential items in one place for use while riding or fishing and allows for convenience of placement.
